(19) United States
(12) Patent Application Publication
(10) Pub. No.: US 2006/0226574 A1
(43) Pub. Date: Oct. 12, 2006

(54) Trim panel

(76) Inventors: Ronald A. Bozio, Holland, MI (US); Bart W. Fox, Zeeland, MI (US); Daniel F. White, Holland, MI (US); Michael J Von Holtz, Holland, MI (US); Jeffrey A. Cussimanio, Holland, MI (US); Delwyn Kragt, Holland, MI (US)

Correspondence Address: Tim McMahon;This is a TEST CASE: DO NOT USE THIS NUMBER, 2717 Arvin St., Wheaton, MD, 20902, US

(21) Appl. No.: 10/569,225

(22) PCT Filed: Aug. 25, 2004
(86) PCT No.: PCT/US04/27588

§ 371 Date: Feb. 23, 2006

(30) Foreign Application Priority Data
Aug. 25, 2003 (US) 60497629

(51) Int. Cl. B29C 45/16

(52) U.S. Cl. 264/248; 264/255

(57) ABSTRACT

A multi-material or multi-color molded article and a method of making the same is provided. The molded article comprises an integrated molded member having at least a first portion made of a first resin and a second portion made of a second resin. The integrated molded member may have additional portions as well. The method comprises providing a mold having a first mold section (24), a second mold section (22), and a retractor member (26), injecting a first resin (18) into a first cavity defined by the first mold section (24), the second mold section (22), and the retractor member (26), moving the retractor member (26) to define a second cavity (23) wherein the second cavity (23) is defined by the first mold section (24), the second mold section (22), the retractor member (26), and the first resin (18), and injecting a second resin (20) into the second cavity (23).

### CROSS-REFERENCE TO RELATED PATENT APPLICATIONS

The present application claims priority to U.S. Provisional Patent Application No. 60/497,629, filed on Aug. 25, 2003 and titled Trim Panel, the full disclosure of which is hereby incorporated herein by reference.

### BACKGROUND

The present application relates to the field of molded articles having multiple colors and/or made from multiple materials. More particularly, the present application relates to the field of trim for vehicle interiors having multiple colors and/or materials.

It is generally known to provide for a vehicle trim panel comprised of multiple colors or multiple materials by connecting multiple pieces. Such known trim panels are typically joined together into one assembly by conventional methods such as ultrasonically welding, adhesives, heat staking or mechanical fastening. Another way of producing a multi-colored trim panel is to mask specific regions and paint the desired color.

However, such multi-piece trim panels have several disadvantages including poor fit and finish due to part and assembly variation. Also, color matching or contrasting may be difficult, particularly when different materials are used.

Accordingly, it would be advantageous to provide a molded article that is molded with multiple colors, materials, textures, and the like. It would also be advantageous to provide a vehicle trim component (e.g., door panel, pillar, instrument panel, console, etc.) with multiple colors and/or multiple materials. It would further be advantageous to provide a multi-color/multi-material trim panel that is molded as (one-piece) an article that does not need secondary joining operations and is not masked and painted. It would further be advantageous to provide a one-piece, multi-color/multi-material panel that is aesthetically desirable and creates unique styling opportunities that would not normally be executed due to high cost and poor fit and finish outcomes associated with traditional methods. It would be desirable to provide for a trim panel having one or more of these or other advantageous features. To provide an inexpensive, reliable, and widely adaptable trim panel that avoids the above-referenced and other problems would represent a significant advance in the art.

### SUMMARY

The present invention relates to a trim panel for use in a vehicle. The trim panel comprises a one-piece molded member having a first portion made of a first resin and a second portion made of a second resin. The one-piece molded member is formed by a process wherein the first resin is injected into a first cavity, a retractor member is moved to define a second cavity without separating the first mold section and the second mold section, and the second resin is injected into the second cavity.

The present invention also relates to a method of making a molded article. The method comprises providing a mold having a first mold section, a second mold section, and a retractor member, injecting a first resin into a first cavity defined by the first mold section, the second mold section, and the retractor member, moving the retractor member to define a second cavity wherein the second cavity is defined by the first mold section, the second mold section, the retractor member, and the first resin, and injecting a second resin into the second cavity.

The present invention further relates to a method of making a molded article. The method comprises providing a mold having a first mold section, a second mold section, and a shut-off member, the shut-off member movable between a first position and a second position and comprising a first surface, a second surface, and a third surface, injecting a first resin into a first cavity which is defined by the first mold section, the second mold section, and the first surface of the shut-off member when in the first position, moving the shut-off member to define a second cavity without moving the first mold section relative to the second mold section, the second mold cavity is defined by the first mold section, the second mold section, the first resin, the second surface of the shut-off member, and the third surface of the shut-off member when in the second position, and injecting a second resin into the second cavity.

The present invention further relates to a method of making a molded article. The method comprises providing a first mold section, a second mold section, and a shut-off member movable between a first position and a second position, injecting a first resin into a first cavity which is defined by the first mold section, the second mold section, and a first portion of the shut-off member when in the first position, moving the shut-off member from the first position to the second position thereby providing a second cavity without moving the first mold section relative to the second mold section, the second mold cavity is defined by the first mold section, the second mold section, the first resin, and a second portion of the shut-off member, and injecting a second resin into the second cavity.

Other embodiments further relates to various features and combinations of features shown and described in the disclosed embodiments.

### BRIEF DESCRIPTION OF THE DRAWINGS

FIG. 1 is a perspective view of a vehicle interior including a door panel and an instrument panel.

FIG. 2 is a perspective view of a door panel.

FIG. 3 is a schematic side section view of a mold with a slide member in an extended position and resin injected into a first cavity.

FIG. 4 is a schematic side section view of the mold of FIG. 3 with the slide member in a retracted position to define a second cavity.

FIG. 5 is a schematic side section view of the mold of FIG. 3 with the slide member in a retracted position and resin injected into the second cavity.

FIG. 6 is a schematic side section view of an article molded in FIGS. 3-5.

FIG. 7 is a schematic side section view of a mold with a slide member in the extended position and a first shot of polymer material injected into a first cavity.

FIG. 8 is a schematic side section view of a mold with a slide member in the retracted position and a second shot of polymer material injected into a second cavity.

FIG. 9 is a side section view of a polymeric article molded as shown in FIGS. 7 and 8.

FIG. 10 is a side section view of polymeric articles molded with varying shut-off geometries and angles.

FIG. 11 is a schematic side section view of a mold with a slide member in an extended position.

FIG. 12 is a section view of an interlocking interface of a first molded portion and a second molded portion of FIG. 9 taken along line 12-12.

FIG. 13 is a section view of an interlocking interface of FIG. 11 according to an alternative embodiment.

FIG. 14 is a schematic side section view of a mold with a slide member in a retracted position and a molded instrument panel.

FIG. 15 is a schematic side section view of a mold with a slide member in a extended position.

FIG. 16 is a schematic side section view of the mold of FIG. 15 with the slide member in a retracted position.

FIG. 17 is a section view of the mold with the extended slide member of FIG. 15 taken along line 17-17.

FIG. 18 is a section view of the mold with the retracted slide member of FIG. 15 taken along line 18-18.

FIG. 19 is a section view of the mold with the extended slide member of FIG. 15 taken along line 19-19.

FIG. 20 is a section view of the mold with the retracted slide member of FIG. 16 taken along line 20-20.

FIG. 21 is a section view of the mold with the extended slide member of FIG. 16 taken along line 21-21.

FIG. 22 is a section view of the mold with the retracted slide member of FIG. 16 taken along line 22-22.

FIG. 23 is a section view of a mold configured to form an article with three materials using two slide members in extended positions and a first polymeric material that has been injected into a first cavity according to an alternative embodiment.

FIG. 24 is a schematic side section view of the mold of FIG. 23 with the slide members in retracted positions.

FIG. 25 is a schematic side section view of the mold of FIG. 24 with a second polymeric material injected into a second cavity and a third polymeric material injected into a third cavity.

FIG. 26 is a schematic side section view of a mold according to an alternative embodiment.

FIG. 27 is a schematic side section view of the mold of FIG. 26.

### DETAILED DESCRIPTION OF THE PREFERRED AND EXEMPLARY EMBODIMENTS

Before proceeding to the detailed description of the preferred and exemplary embodiments, several comments can be made about the general applicability and the scope thereof.

First, while the components of the disclosed embodiments will be illustrated as door trim panels, instrument panels, and the like, designed for a vehicle, the features of the disclosed embodiments have a much wider applicability. For example, the multiple injection design is adaptable for other panels, molded articles and components for office, home, or educational, industrial, commercial, or consumer products that employ a multiple resins configured to provide different structural properties, colors, textures, or the like. Further, the size of the various molded articles and the size of the panels can be widely varied.

Second, the particular materials used to construct the exemplary embodiments are also illustrative. It is important to note that the terms “multi-color,” “multi-material,” “multiple colors,” “multi-shot,” and “different” polymers (or “plastics,” “polymeric materials,” “polymeric resins” and the like) as used herein are intended to be broad terms and not terms of limitation. The resins may be different colors of the same polymer, different polymers that have the same color, different polymers that have different colors, and the like. Any of a variety of materials can be used, including polymers such as thermoplastics, thermosets, elastomers, and the like. For example, any variety of thermoplastic resins such as polypropylene, polyethylene, high density polyethylene, acrylonitrile butadiene styrene (“ABS”), polycarbonate, vinyl, polyester, polyurethane, thermoplastic elastomer (TPE), thermoplastic elastomer polyolefin (TPO), thermoplastic vulcanizate (TPV), polyvinyl chloride (PVC), nylon, any of a variety of homopolymer plastics, copolymer plastics, plastics with special additives, filled plastics, or the like may be used. Also, any of a variety of thermoset resin such as phenolics, thermosetting polyester, silicone, polyurethane elastomers, or the like may be used. Further, any of a variety of elastomer resins such as rubber, butyl, synthetic elastomer (SBR), or the like may be used. There may be one, two, three, or more polymers that are co-molded or sequentially molded. The molding operation is preferably injection molding, but any of a variety of molding operations may be used such as reaction injection molding (RIM), transfer molding or the like. Also, descriptions or claims that identify or recite a “first resin” and a “second resin,” a “first polymeric material” and a “second polymeric material,” or a “first color” and a “second color” are intended to be broad terms and not limited to one, two, etc. resins, materials, or colors (i.e., cover articles that have three, four, etc. resins, materials, and colors, or combinations thereof).

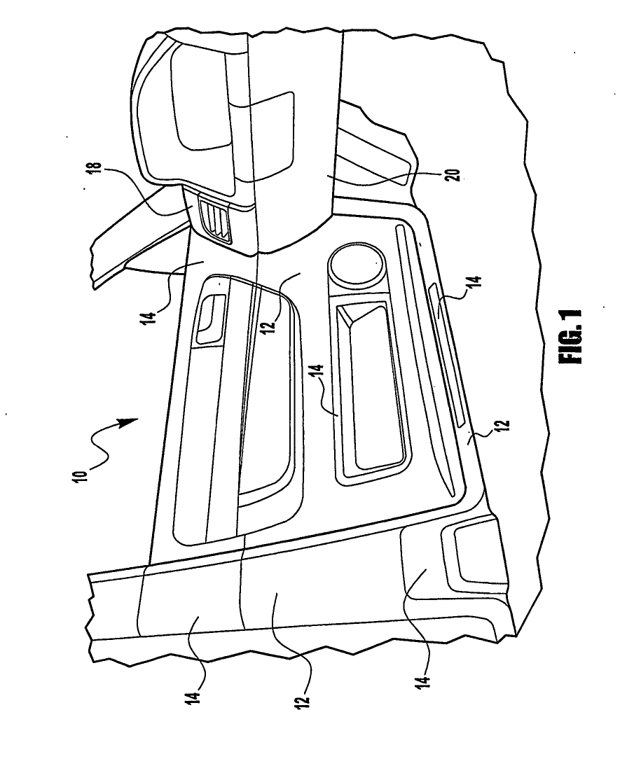

Proceeding now to descriptions of the preferred and exemplary embodiments, FIGS. 1 and 2 illustrate molded articles in the form of trim panels 10 (shown in FIG. 1 as an instrument trim panel and a door trim panel, and shown in FIG. 2 as a door trim panel). The trim panel 10 is manufactured (molded) from a process that allows for multiple colors and/or multiple materials to be allocated (positioned, located, molded, placed, etc.) at different portions of the trim panel. According to an exemplary embodiment, the process for making such a molded article includes multiple injections into a mold that is reconfigured during the molding operation, as further described below.

The advantages for this type of trim panel include the ability to localize and strategically place multiple colors and/or use of more premium materials that yield soft touch, low gloss, impact resistance, UV protection, high heat performance, or the like. For example, it is desirable to have soft touch or UV resistant additives on only the upper portion of a door panel or an instrument panel. Another advantage of this type of trim panel is the improvement of fit and finish because it is one-piece (as opposed to mechanically-joined multiple pieces) and produced in the same process.

There are many styling opportunities that can be realized with such an integral multi-shot trim panel when compared to a conventional multiple-piece trim panel. The two-color color boundary may run (e.g., transition, pass, etc.) through an opening or another component. Isolated color break-ups that make a feature look separate may be realized in the one-piece trim panel such as a different color molded-in speaker grille or map pocket border. Multi-color pillar trim may be provided to allow flow-through from the interior's front to rear without having to break the trim into multiple pieces. Accents in scuff plates and other trim may be produced in the same piece. Part separation does not have to dictate color break-up location. Specific details and features can be highlighted in a different color.

FIGS. 1 and 2 illustrate alternative styling embodiments using the disclosed method. For example, FIG. 1 illustrates several colors in one part, such as a two-tone door and separately-colored panels. Separate parts (e.g., soft-skinned area) can bridge two colors without fit issues. Also, isolated color break-ups (e.g., molded-in speaker griller made to look separate, and map pocket surround) may be used. FIG. 2 illustrates part separation requirements that need not dictate color break-up location, which would be useful on quarter trim and B-pillar trim of a vehicle. Smaller details that would create fit or masking problems could also be achieved. Smaller detail or components such as cargo hooks or tie-down hook highlights can be molded-in.

The method is further shown and described below, but generally uses a multi-shot molding technique (e.g., injection moding, spin molding, transfer molding, over molding, or the like) to produce a one-piece, multi-color/multi-material trim panel. The mold includes a core, a cavity, and a retractor. The first “shot” of polymeric resin material (representative of a first portion 12 of trim panel 10) is constrained within the mold corresponding to a particular region on the trim panel by a first cavity defined by the retractor, core, and cavity. Once the first cavity is filled with polymeric resin, the retractor is displaced (preferably by approximately the thickness of the part) to provide a second cavity 23 defined by the displaced retractor, cavity, core, and the first polymeric resin. The second “shot” (representative of a second portion 14 of trim panel 10) then fills the second cavity with polymeric resin that flows to and bonds with the first material boundary. According to an exemplary embodiment, the second shot is provided by a secondary injection unit. The retractor provides the shut-off for the polymeric resin by not contacting the mold such that there is a space or gap between the retractor and the opposing mold section, which is intended to provide a vent to allow air to escape from the first cavity as the resin fills the first cavity. Alternatively, the retractor shuts-off by contacting the mold. According to a preferred embodiment, the first material is at least partially solidified when the second material is injected.

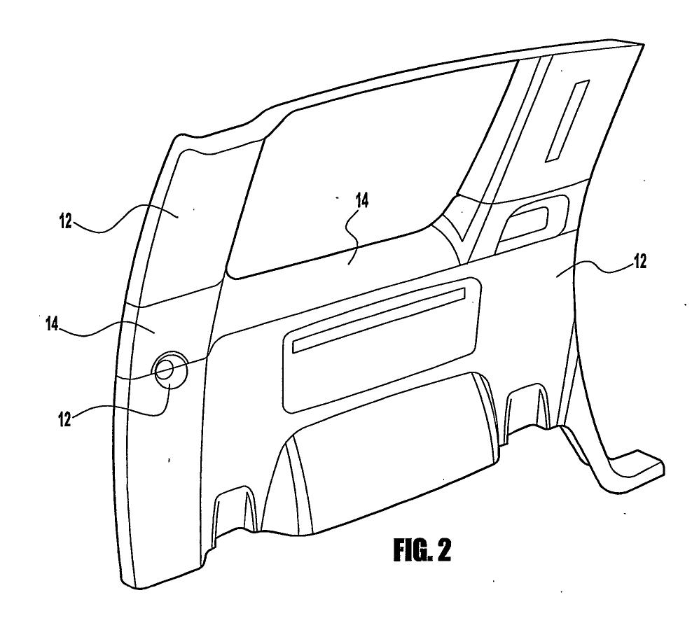

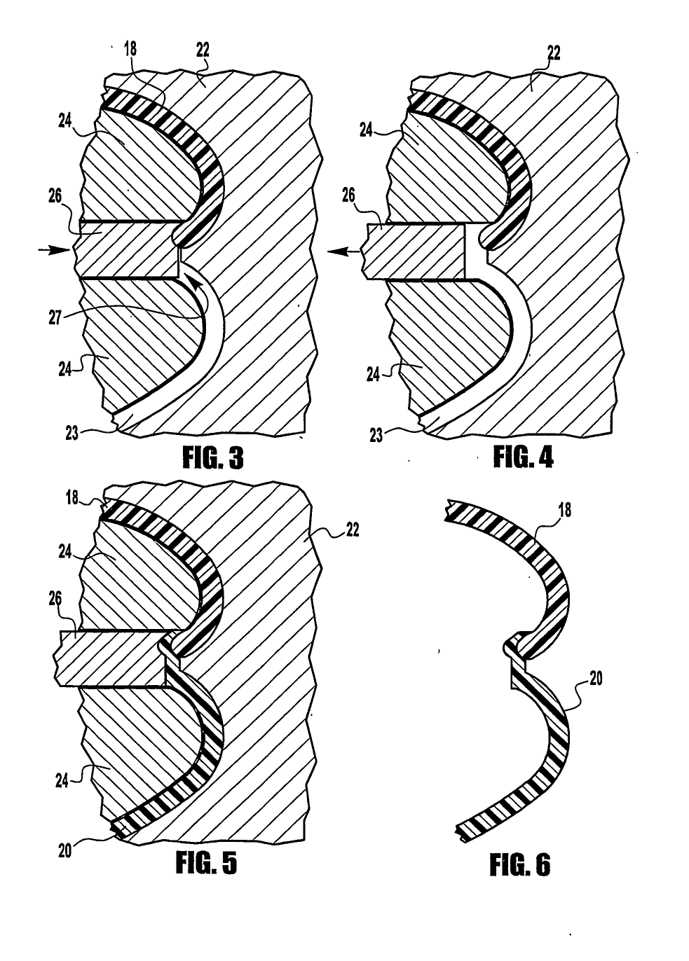

The one-piece molded member further comprises an “A” surface (i.e., surface of molded article that is visible to a vehicle occupant) and a “B” surface (i.e., surface of the molded article that is not visible). The “A” surface is generally defined by a portion of the polymeric resin that is injected first, a portion of the polymeric resin that is injected second, and an interface between the two polymeric materials (e.g., at a recess or groove). The portion of the two injected polymeric resins that overlap is generally not visible. The recess is located on the “A” surface. The surface on the retractor that contacts (or be spaced apart from) the opposite side of the mold can be perpendicular to or at an angle relative to the direction of the die (mold, tool, etc.) draw. According to an exemplary embodiment (shown in FIGS. 3-6), the perpendicular retractor surface is configured to provide a “square” recess (e.g., ditch, indent, etc.) at the two-shot boundary.

According to another exemplary embodiment (shown in FIGS. 7-10), an angled shut-off (shown as surface 28 of a retractor 30) is configured to provide an angled recess 36 that is intended to allow the two-shot boundary to be hidden from the occupant's sight for most in-car positions. This angled shut-off 28 creates an apparent geometric gap or transition that may be more desired (for some molded articles) than a square, mechanical recess because it can hide the material joint.

The shut-off surface on the retractor (either perpendicular to or at an angle to die draw) is designed to withstand molding pressures and prevent injected polymer from flowing into other areas of the tool. FIGS. 7-11 illustrate exemplary cross sections of square and angled two-shot boundary recesses or ditches that could be applied to a molded article (such as a trim panel, instrument panel, etc.). For example, trim panel 10 includes a first portion comprising a first color and a second portion comprising a second color. Portions of the trim panel is manufactured using a mold that is reconfigured during the molding operation during a process with shut-off stages so that polymeric resin of different colors is injected into the mold at different times.

FIGS. 3-5 show a fragmentary sectional view of a mold during a molding operation for an instrument panel. According to an exemplary embodiment, the mold includes a cavity 22, a core 24, and a slide or retractor 26. Preferably, the retractor 26 is at least partially disposed in the core 24. Preferably, the “A” surface (or “show surface”) of the molded article is provided by the cavity 22 and the “B” surface is provided by core 24. According to alternative embodiments, the retractor is disposed in the cavity and/or the “A” surface is provided by the core.

The retractor 26 is configured to move between a first position and a second position (shown in broken lines) during the molding operation. According to alternative embodiments, the retractor is configured to move to three or more positions (e.g., a third position, etc.) during the molding operation. The slide or retractor 26 may be moved using any number of methods, including a spring-loaded and wedge system (so that when the mold sections open, the slide moves back into one of the mold sections), by hydraulics, pneumatics, mechanically, or the like.

The mold shown in FIG. 3 includes a vent 27 between the retractor 26 and the cavity 22. Vent 27 is provided by retractor 26 not shutting off against cavity 22 (i.e., so that the gap or space exists) so that air from the first cavity can escape through vent 27 as the first polymeric resin as injected into the first cavity. According to an alternative embodiment, the retractor may be designed to “shut-off” against the cavity by contacting the mold (i.e., no vent). According to yet another alternative embodiment, the lower portion 20 of the molded article (instrument panel) may be molded first (e.g., by rotating the retractor around, for the geometry shown).

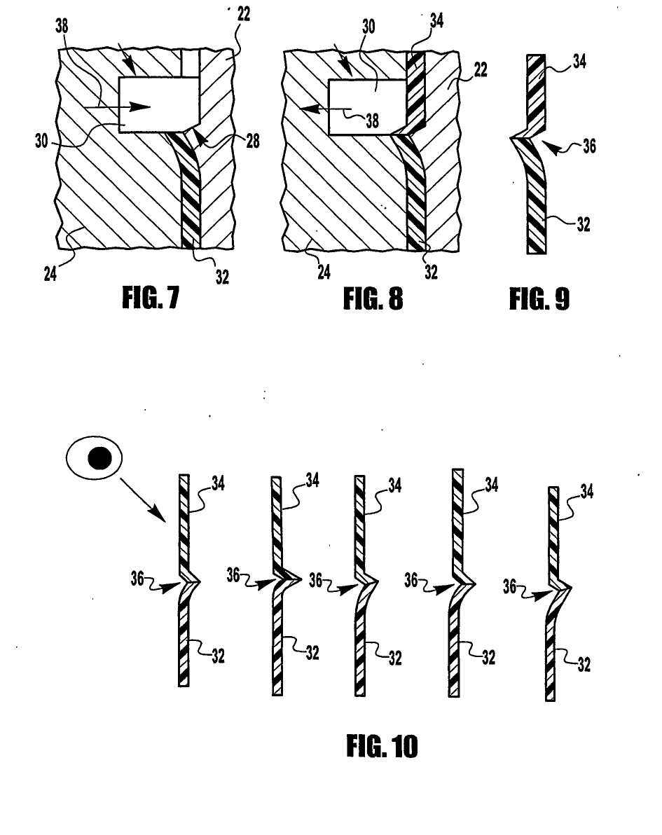

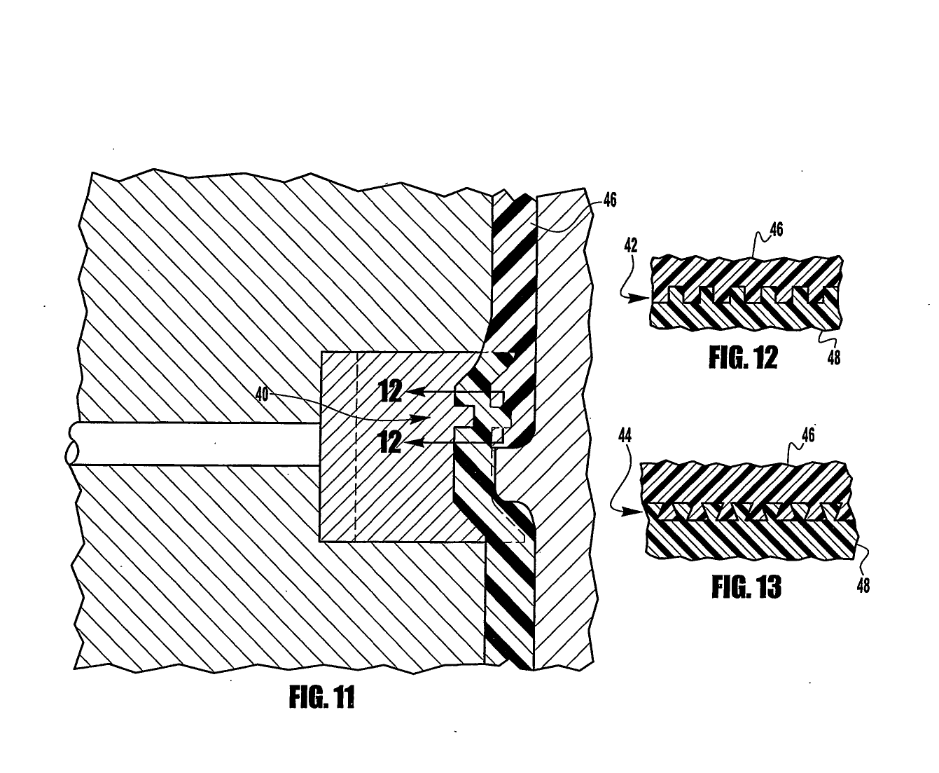

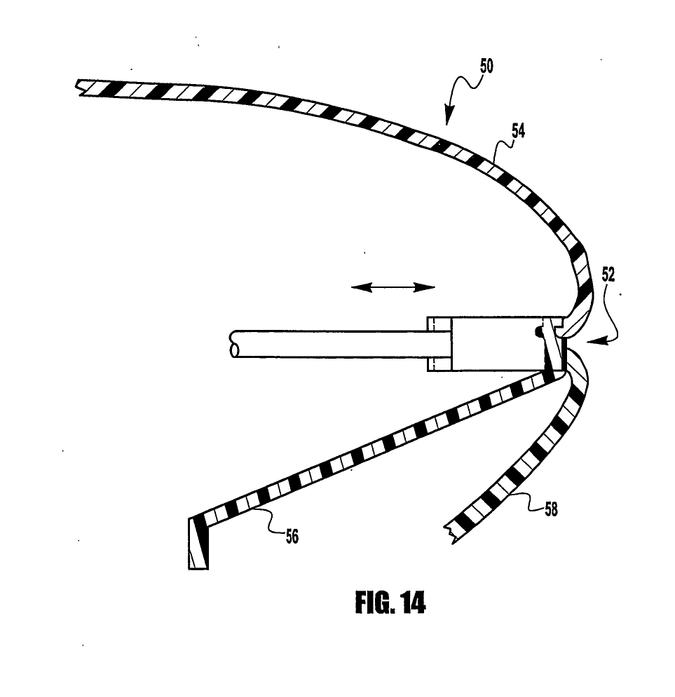

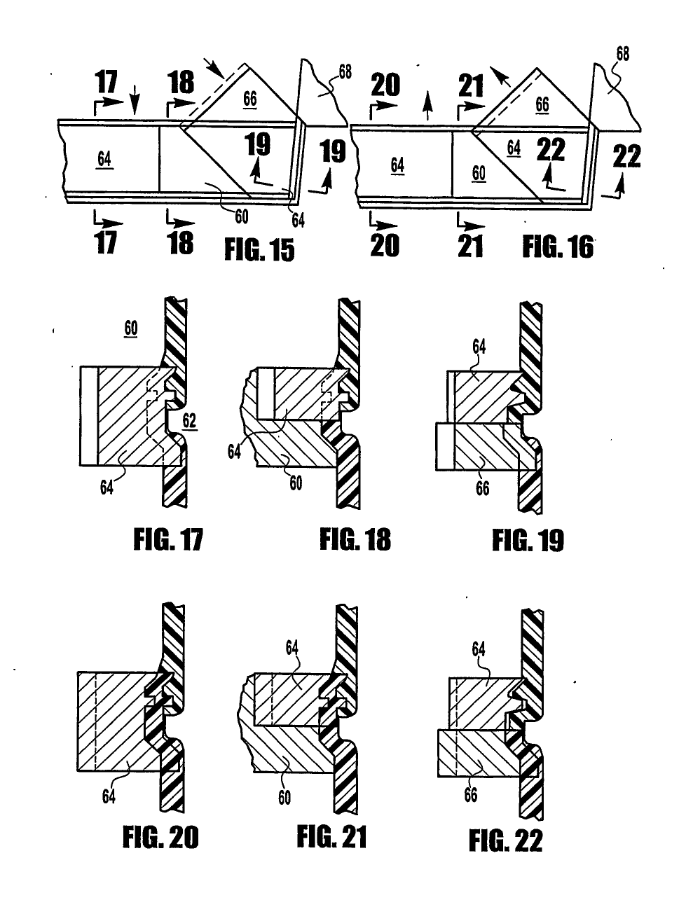

According to an exemplary embodiment, FIGS. 7 and 8 illustrate movement of a retractor 30 to provide for the first cavity and then the second cavity during the molding operation. Referring to FIG. 7, for the first shot 30, the retractor 30 closes-off on the cavity-half of the mold to prevent the first shot from entering into upper portion of tool (shown as the second cavity). The first shot is injected into the first cavity.

Referring to FIG. 8, for the second shot 34, the retractor 30 is pulled back to open the upper portion of the tool and provide the second cavity. Preferably, the retractor 30 moves approximately a wall-stock thickness. The second shot is injected and stops flowing when it reaches the first material. FIG. 9 illustrates the finished part.

Referring to FIG. 10, examples of shut-off geometries are illustrated. The shut-off geometry allows the intersection or interface of the two materials (injections or “shots”) to be hidden from view. According to an exemplary embodiment, the shut-off geometry provides for a recess 36 that has outer surfaces that are angled relative to the major surface of the molded part. According to a preferred embodiment, the recess 36 is angled so that interface of the two materials is hidden (e.g., at least partially, substantially, etc.) from the line of site of the vehicle occupants. According to an exemplary embodiment, the angled recess geometry is provided by an angled shut-off surface. Referring to FIG. 10, an arrow 38 illustrates the direction of the draw of the retractor and the mold die.

Referring to FIGS. 11-13, an interlocking geometry is created to provide a mechanical lock in addition to any chemical bond (e.g., fused polymeric resin) that exists to improve the strength of the two-shot boundary. According to a preferred embodiment, the molded article includes interlocking geometries and an angled shut-off. FIG. 11 is a fragmentary side section view of the mold configured to provide a molded article with a mechanical interlock 40. The mechanical interlock 40 is provided by one or more (or a series of) projections and/or recesses on the retractor. FIG. 12 illustrates a section of a square mechanical interlock 42 wherein the projections and/or recesses on the retractor have a square cross-section. FIG. 13 illustrates a section of a dovetail mechanical interlock 44 wherein the projections and/or recesses on the retractor have angled sides (e.g., to provide additional interlock, directional stability). The first shot 46 is shown in a first color and the second shot 48 is shown in a second color. As such, the locking direction is vertical.

FIG. 14 illustrates another exemplary molded article (shown as a portion of an instrument panel 16). The instrument panel 16 includes an upper portion 18 molded with a first color and a lower portion 20 molded with a second color. FIG. 14 is a side section view of a vehicle instrument panel 50 with a square recess 52 separating an upper portion 54 and a lower portion. The lower portion of the instrument panel 50 includes a glove box section 56 (which defines the rear wall of a glove box) and an outboard section 58 (which typically provides a generally flush surface with the glove box door (not shown)). According to an exemplary embodiment, the upper portion 54 of the instrument panel 50 is molded first and then the lower portion of the instrument panel 50 is molded.

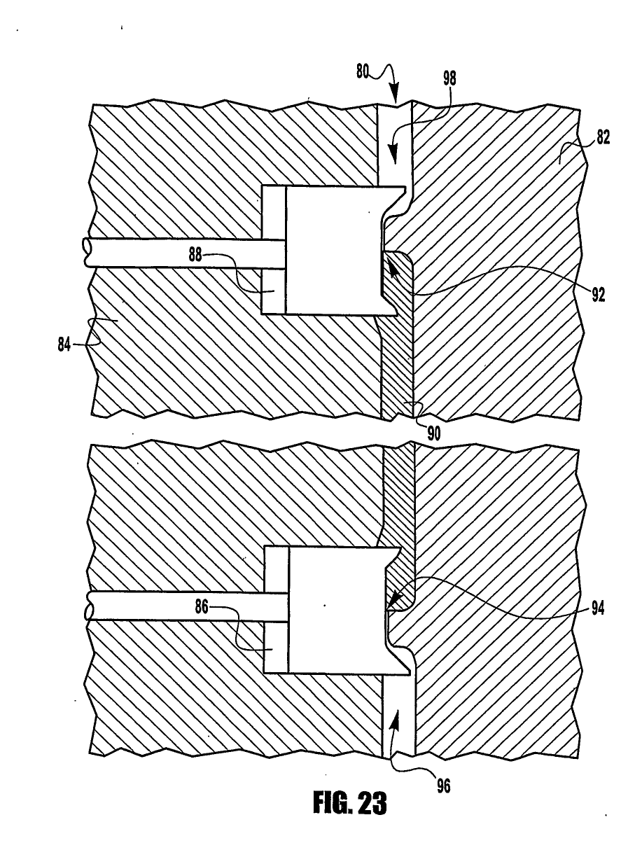

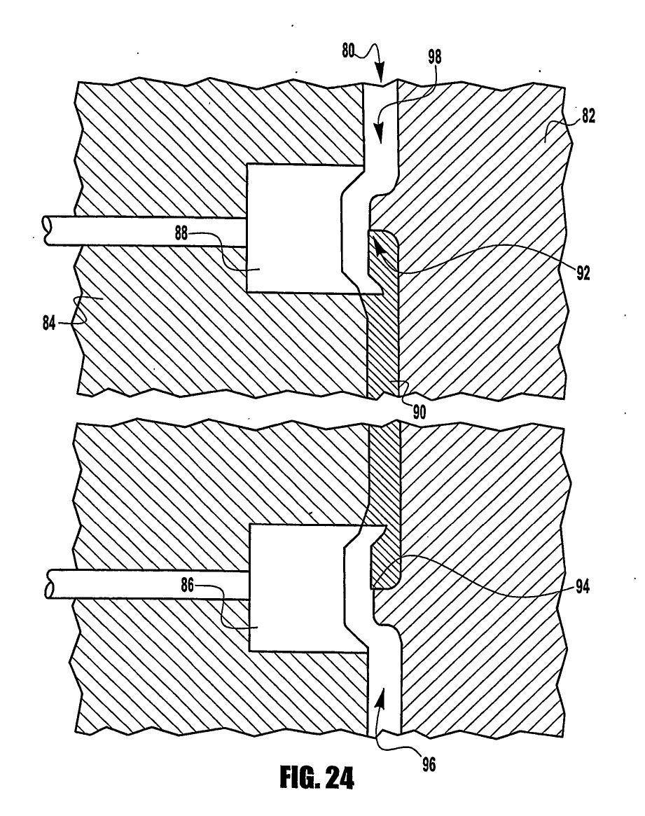

FIGS. 15-22 illustrate a retractor concept for allowing vertical walls (parallel to die draw) to be full material thickness (e.g., for use in forming at corners) according to an exemplary embodiment. FIGS. 15 and 16 are a horizontal section of the mold having a core 60, a cavity 62, a first retractor 64, a second retractor 66 and a secondary slide 68. Secondary slide 68 is configured to provide molded in detail for this particular molded article (i.e., recesses to receive an end cap for an instrument panel). FIGS. 17-22 are vertical section views of the mold and the molded article (as it is molded). FIGS. 17-19 are vertical sections of the mold when the first portion (having a first color) of the molded article is injected with a first material. FIGS. 20-22 are vertical sections of the mold when the second portion (having a second color) of the molded article is injected with a second material. As shown, use of the second retractor 66 is used to provide additional wall thickness.

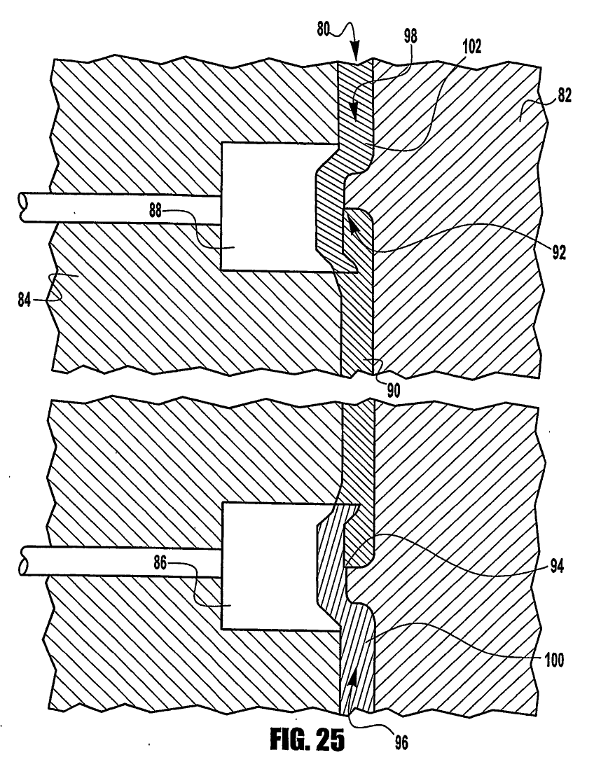

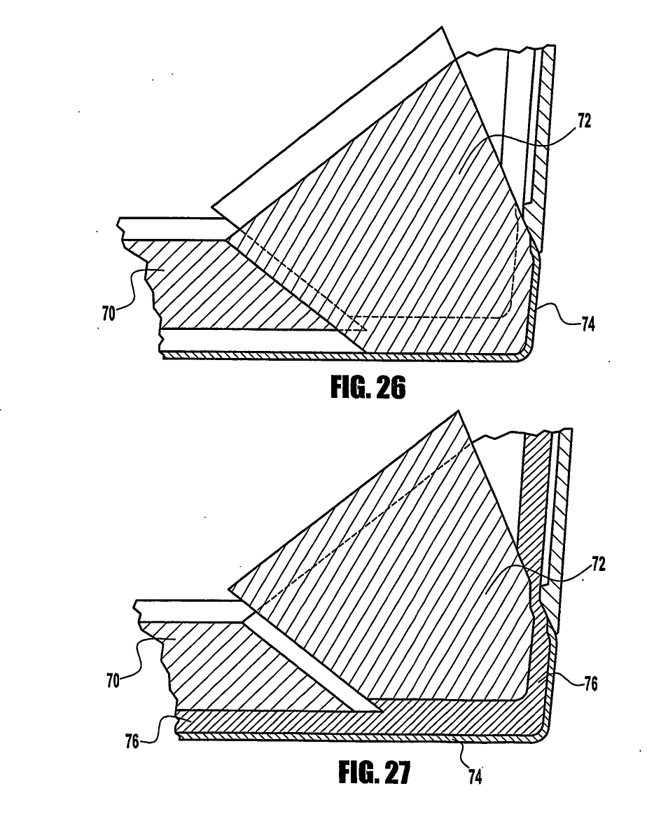

FIGS. 23-25 show a process for molding a molding article (trim panel 80) with three resin shots. FIG. 23 is a section view of a mold configured to form an article with three materials using two slide members in extended positions and a first polymeric material injected into a first cavity according to an alternative embodiment. FIG. 24 is a schematic side section view of a mold with the slide members in retracted positions. FIG. 25 is a schematic side section view of a mold with a second polymeric material injected into a second cavity and a third polymeric material injected into a third cavity.

The method uses a multi-shot molding techniques to produce a one-piece, multi-color/multi-material trim panel 80 by integration the three resin materials into a single substrate. The mold includes a cavity 82, a core 84, a first retractor 86, and a second retractor 88.

The first shot of polymeric material 90 (representative of a first portion of trim panel 80) is constrained within the mold corresponding to a particular region on trim panel 80 by retractors 86, 88.

The mold shown in FIG. 23 includes a vent 92 between retractor 86 and cavity 82 and a vent 94 between retractor 88 and cavity 82. According to an alternative embodiment, the retractors may be designed to “shut-off” against the cavity (i.e., no vent).

Once the first cavity is filled with polymer resin 90, first retractor 86 is displaced to provide a second cavity 96 (defined by the displaced first retractor 86, cavity 82, core 84, and first material 90), and second retractor 88 is displaced (preferably by approximately the thickness of the part) to provide a third cavity 98 (defined by the displaced second retractor 88, cavity 82, core 84, and first material 90. The first retractor 86 and second retractor 88 are configured to move between a first position and a second position during the molding operation (i.e., the mold is reconfigurable). First retractor 86 and second retractor 88 may be configured to move at the same time or move at separate times. The second polymeric resin 100 and the third polymeric resin 102 may be configured to be injected at the same time or at different times. According to alternative embodiments, the retractors are configured to move to three or more positions (e.g., a third position, etc.) during the molding operation. The retractors may be moved using any number of methods, including a spring-loaded system (so that when the mold sections open, the slide moves back into one of the mold sections), by hydraulics, pneumatics, mechanically, or the like.

The second shot of polymeric material 100 (representative of a second portion of trim panel 80) then fills the second cavity 96 and polymer flows to and bonds with the first material boundary. The second shot may be provided by a secondary injection unit. According to a preferred embodiment, the first material is at least partially solidified when the second material is injected.

The third shot of polymeric material 102 (representative of a third portion of trim panel 80) then fills the third cavity 98 and polymer flows to and bonds with the first material boundary. The third shot may be provided by a third injection unit. According to a preferred embodiment, the first material is at least partially solidified when the third material is injected.

Referring to FIGS. 23-25, the process may have any of a variety of sequences. For example, the first retractor 86 may be moved before the second retractor 88 and then the polymeric material may be injected at the same time or one after the other. Alternatively, the first retractor may be moved before (or after) the second retractor and the n the polymeric material may be injected at the same time or one after the other (e.g. before, during, or after the movement of the other retractor).

FIGS. 26 and 27 illustrate a retractor system for allowing vertical walls (parallel to die draw) to be fall material thickness. A mold for a molded article includes a first retractor or slide 70 and a second retractor or slide 72. The first slide 70 moves generally perpendicular relative to the major portion of the molded article. The second slide 72 moves generally angular (diagonal) relative to the major portion of the molded article. The molded article includes a first portion 74 made from the first injection (or “shot”) and a second portion 76 made from the second injection (or “shot”). The mold shown in FIGS. 26 and 27 is different than the mold shown in FIGS. 3-5 in that the core portion between the first slide 70 and the second slide 72 has been eliminated and the two slides are shaped so that the movement of the two slides 70, 72 provide for the cavity space to receive the polymeric resin injections.

It is also important to note that the construction and arrangement of the elements of the molded article (such as a trim panel) as shown in the preferred and other exemplary embodiments are illustrative only. Although only a few embodiments of the present invention have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the claims. For example, different “materials” used in the disclosed method may be different colors of the same polymeric resin, configured to provide different textures; and the like. Also, different materials may be different polymeric resins of the same or different color. Also, the disclosed process may be used on any of a variety of molded polymeric articles, including vehicle components. One embodiment relates to a molded article formed by a process wherein a first material is injected into a first cavity, a retractor member is moved to define a second cavity, and a second material is injected into the second cavity. The first and second materials may be different types of polymers, different colors, or combinations thereof. The first cavity is defined by two mold sections (e.g., a cavity and a core) and the retractor member. The second cavity is also defined by the two mold sections, the retractor member, and the (at least partially) hardened first material. The first material may be configured to couple to the second material by a locking interface provided by recesses and/or projections on the mold sections. The molded article may be a door trim panel or vehicle instrument panel, or the like. One embodiment relates to a method of making a molded article comprising providing a mold having a core, a cavity, and a retractor member. The method also comprises injecting a first material into a first cavity which is defined by the core, cavity, and retractor. The method further comprises moving the retractor member to at least partially define a second cavity wherein the second cavity is defined by the core, cavity, retractor member, and the first material. The method further comprises injecting a second material into the second cavity. Accordingly, all such modifications are intended to be included within the scope of the present invention as defined in the appended claims. The order or sequence of any process or method steps may be varied or re-sequenced according to alternative embodiments. In the claims, any means-plus-function clause is intended to cover the structures described herein as performing the recited function and not only structural equivalents but also equivalent structures. Other substitutions, modifications, changes and/or omissions maybe made in the design, operating conditions and arrangement of the preferred and other exemplary embodiments without departing from the spirit of the present invention as expressed in the appended claims.

1-37. (canceled)

38. A method of making a molded article for a vehicle interior, the method comprising:
providing a mold having a first mold section, a second mold section, and a shut-off member, the shut-off member movable between a first position and a second position and comprising a forward surface, a first side surface, a second side surface that shares an edge with the forward surface, and an angled surface that extends between the forward surface and the first side surface;
injecting a first resin into a first cavity which is defined by the first mold section, the second mold section, and the first side surface of the shut-off member when in the first position;
moving the shut-off member to define a second cavity defined by the first mold section, the second mold section, the first resin, the second side surface of the shut-off member, and the angled surface of the shut-off member when in the second position; and
injecting a second resin into the second cavity and forming an angled recess in the molded article having an upper surface provided by the angled surface of the shut-off member, wherein the upper surface is provided at a sufficiently flat angle relative to vertical by the angled surface of the shut-off member to obscure the interface between the first resin and the second resin from an occupant of the vehicle interior.

39. The method of claim 38 wherein the first resin is at least partially solidified when the second resin is injected.

40. The method of claim 38 further comprising a space between the shut-off member and the second mold section when the shut-off member is in the first position so that air can escape from the first cavity to the second cavity during the step of injecting the first resin into the first cavity.

41. The method of claim 38 wherein the first resin comprises a first color and the second resin comprises a second color different than the first color.

42. The trim panel of claim 38 wherein the first resin comprises at least one of a thermoplastic material, a thermoset material, or a elastomer material.

43. The trim panel of claim 42 wherein the second resin comprises at least one of a thermoplastic material, a thermoset material, or a elastomer material.

44. A method of making a molded article, the method comprising:
providing a mold having a first mold section, a second mold section, a first shut off member and a second shut-off member, the shut-off members are each separately movable between a first position and a second position;
injecting a first resin into a first cavity which is defined by the first mold section, the second mold section, the first shut-off member in the first position, and the second shut-off member in the first position;
moving the first shut-off member to the second position to define a second cavity without moving the first mold section relative to the second mold section wherein the second cavity is defined by the first mold section, the second mold section, the first material and the first shut-off member in the second position;
moving the second shut-off member to the second position to define a third cavity without moving the first mold section relative to the second mold section wherein the third cavity is defined by the first mold section, the second mold section, the first material, and the second shut-off member in the second position;
injecting a second resin into the second cavity; and
injecting a third resin into the third cavity.

45. The method of claim 44 wherein moving the first shut-off member between the first position and the second position comprises translating movement.

46. The method of claim 45 wherein the first position comprises an extended position and the second position comprises a retracted position wherein the shut-off member is disposed substantially within the first mold section.

47. The method of claim 44 further comprising a gap between the first shut-off member and the second mold section when the first shut-off member in the first position.

48. The method of claim 47 wherein the gap is configured to provide a vent to allow air to escape the first mold cavity when injecting the first resin into the first cavity.

49. The method of claim 44 further comprising the step of bonding the second resin to the first resin and bonding the third resin to the first resin.

50. The method of claim 49 wherein bonding the second resin to the first resin comprises fusion bonding and bonding the third resin to the first resin comprises fusion bonding.

51. The method of claim 44 wherein the third resin comprises at least one of a thermoplastic material, a thermoset material, or a elastomer material.

52. The method of claim 51 wherein the first resin comprises at least one of a thermoplastic material, a thermoset material, or a elastomer material.

53. The method of claim 52 wherein the second resin comprises at least one of a thermoplastic material, a thermoset material, or a elastomer material.

54. The method of claim 44 wherein the first shut-off member moves at about the same time as the second shut-off member.

55. The method of claim 44 wherein the first shut-off member moves before the second shut-off member.

56. The method of claim 44 wherein moving the first shut-off member comprises moving the first shut-off member in a first direction and moving the second shut-off member comprises moving the second shut-off member in a second direction that is parallel to the first direction.

57. The method of claim 44 wherein moving the first shut-off member comprises moving the first shut-off member in a first direction and moving the second shut-off member comprises moving the second shut-off member in a second direction that is not parallel to the first direction.

58. The method of claim 44 wherein the first resin comprises a first material property and the second resin comprises a second material property different than the first material property.

59. The method of claim 44 wherein the first resin comprises a first color and the second resin comprises a second color different than the first color.

60. The method of claim 44 wherein at least one of the first resin and the second resin comprises a material property different than the third resin.

61. A method of making a molded article for a vehicle interior, the method comprising:
providing a mold having a first mold section, a second mold section, a first shut off member and a second shut-off member, the shut-off members are each separately movable between a first position and a second position;
injecting a first resin into a first cavity defined by the first mold section, the second mold section, the first shut-off member in the first position, and the second shut-off member in the first position;
moving the first shut-off member to the second position and moving the second shut-off member to the second position to define a second cavity defined by the first mold section, the second mold section, the first material, the first shut-off member in the second position, and the second shut-off member in the second position;
injecting a second resin into the second cavity.

62. The method of claim 61 wherein the first resin provides the molded article with a first wall thickness located between the second shut-off member and the first mold section, and the second resin provides the molded article with a second wall thickness located between the second shut-off member and the first mold section and including the first wall thickness.
